(19) United States
(12) Patent Application Publication
(10) Pub. No.: US 2022/0206831 A1
(43) Pub. Date: Jun. 30, 2022

(54) METHOD AND SYSTEM FOR MANAGING APPLICATIONS ON A VIRTUAL MACHINE

(71) Applicant: ATI Technologies ULC, Markham (CA)

(72) Inventors: Vignesh Chander, Markham (CA); Rohit S. Khaire, Markham (CA)

(73) Assignee: ATI Technologies ULC, Markham (CA)

(21) Appl. No.: 17/135,975

(22) Filed: Dec. 28, 2020

(51) Int. Cl. G06F 9/455; G06F 9/50

(52) U.S. Cl. CPC G06F 9/45558; G06F 9/5077; G06F 2209/501; G06F 2009/45587; G06F 2009/45562

(57) ABSTRACT

A method and system for managing applications on a virtual machine includes creating a plurality of virtual machines on a computer system. Each virtual machine is isolated from one another. Resources are allocated to each virtual machine based upon a resource requirement of an application executing on each virtual machine.

### BACKGROUND

On a conventional graphics processing unit (GPU)/central processing unit (CPU) system multiple applications are typically executed at the same time. A potential issue with this executing of multiple applications is that the applications compete with one another for resources. Conventional software and hardware solutions do not provide isolation between the executing applications, which can affect each application's performance.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of a conventional system;

FIG. 3 is a block diagram of a conventional virtualized system;

FIG. 4 is a block diagram of an example equalized virtual machine system in accordance with an embodiment;

FIG. 5 is a block diagram of an example unequalized virtual machine system in accordance with an embodiment; and

FIG. 6 is a flow diagram of an example method of managing applications on a virtual machine.

### DETAILED DESCRIPTION

Although the method and apparatus will be expanded upon in further detail below, briefly a method for and apparatus for managing applications on a virtual machine is described herein.

Virtualization in a computer system uses multiplexing (e.g., time slicing, etc.) to create a virtual machine to run applications. In addition, a portion of resources may be provided to a first virtual machine (VM) while a second portion of resources are provided to a second VM.

This is performed by creating an isolation layer in the processor (or processors) executing the applications that keep them separate from one another. However, by running the applications in isolation, performance issues may arise with one or more of the applications. In some cases, a user may desire that an application have isolation but also maintain certain performance levels, such as quality of service (QoS) levels.

A method for managing applications on a virtual machine includes creating a plurality of virtual machines on a computer system. Each virtual machine is isolated from one another. Resources are allocated to each virtual machine based upon a resource requirement of an application executing on each virtual machine.

A computer system for managing applications includes a memory and a processor operatively coupled to and in communication with the memory. The processor is configured to create a plurality of virtual machines within the processor, isolate each virtual machine from one another, and allocate resources to each virtual machine based upon a resource requirement of an application executing on each virtual machine.

A non-transitory computer-readable medium for managing applications, the non-transitory computer-readable medium having instructions recorded thereon, that when executed by the processor, cause the processor to perform operations. The operations include creating a plurality of virtual machines on a computer system. Each virtual machine is isolated from one another. Resources are allocated to each virtual machine based upon a resource requirement of an application executing on each virtual machine.

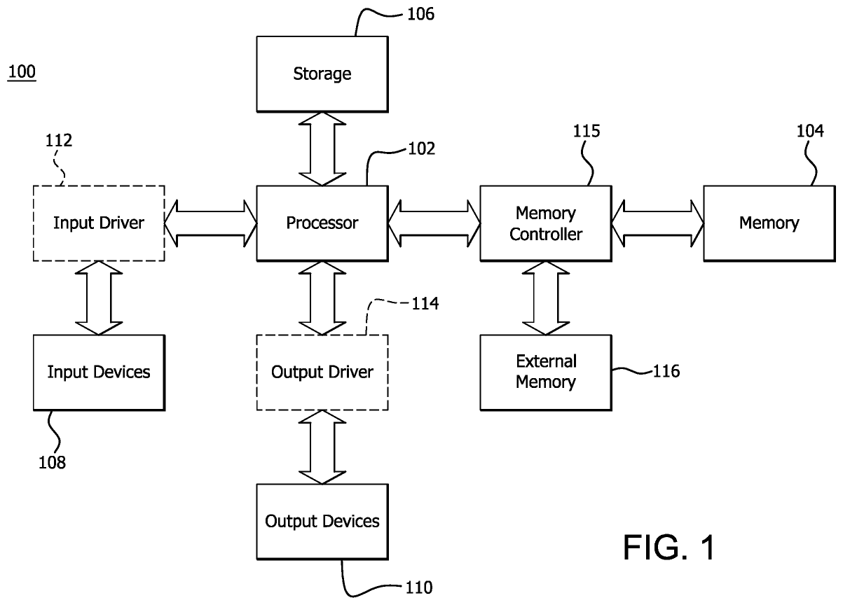

FIG. 1 is a block diagram of an example device 100 in which one or more features of the disclosure can be implemented. The device 100 can include, for example, a computer, a server, a gaming device, a handheld device, a set-top box, a television, a mobile phone, or a tablet computer. The device 100 includes a processor 102, a memory 104, a storage 106, one or more input devices 108, and one or more output devices 110. The device 100 can also optionally include an input driver 112 and an output driver 114. Additionally, the device 100 includes a memory controller 115 that communicates with the processor 102 and the memory 104, and also can communicate with an external memory 116. In some embodiments, memory controller 115 will be included within processor 102. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present.

The external memory 116 may be similar to the memory 104, and may reside in the form of off-chip memory. Additionally, the external memory may be memory resident in a server where the memory controller 115 communicates over a network interface to access the memory 116.

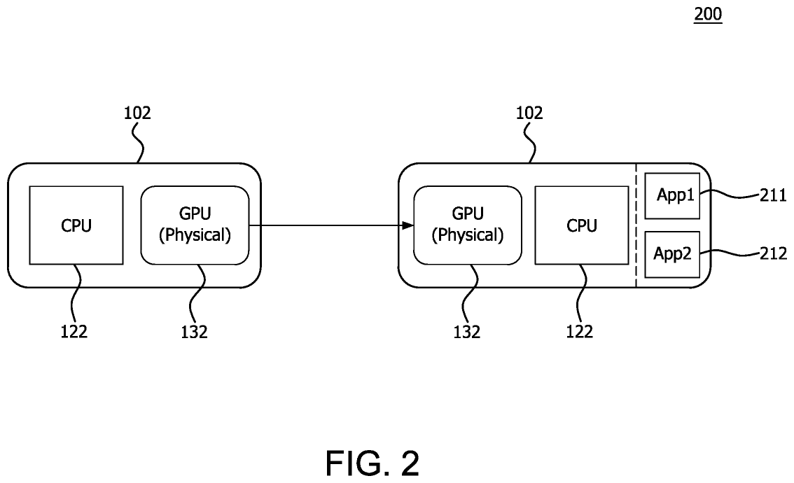

FIG. 2 is a block diagram of a conventional system 200. The system 200 includes, for example, the processor 102 (which may be a CPU 122 or physical GPU 132). In the system 200, the CPU and GPU execute applications 211 (App1) and 212 (App2), for example.

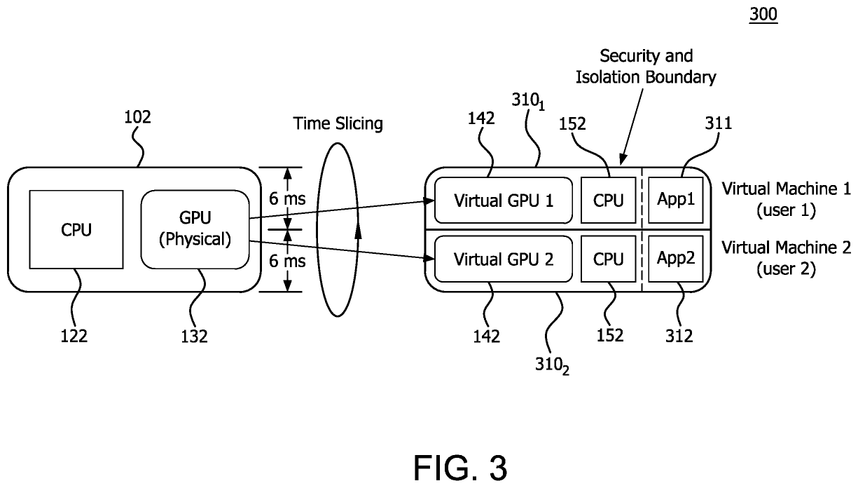

FIG. 3 is a block diagram of a conventional virtualized system 300. Similar to system 200, the system 300 also includes processor 102. In this system, two virtual machines (VMs) 310₁ (VM1) and 310₂ (VM2) are created using the CPU 122 and the GPU 132. The VMs 310 include an isolation boundary to provide security between them such that user 1 on VM1 is isolated while running App1 from user 2 running App2 on VM 2.

For example, to provide isolation between VMs which are sharing physical resources such as processors, memory, and other components on a same system, it is necessary to isolate the operations of each VM and applications executing on each VM from one another to provide security between them such that data intended for VM1 is not provided to VM2 and vice versa. In one example, the VMs are isolated by separating them in the time domain by slicing 6 ms intervals, for example.

FIG. 3 shows an example where multiple users are using multiple applications. In the example shown in FIG. 3, there are two users using two VMs (310₁ and 310₂).

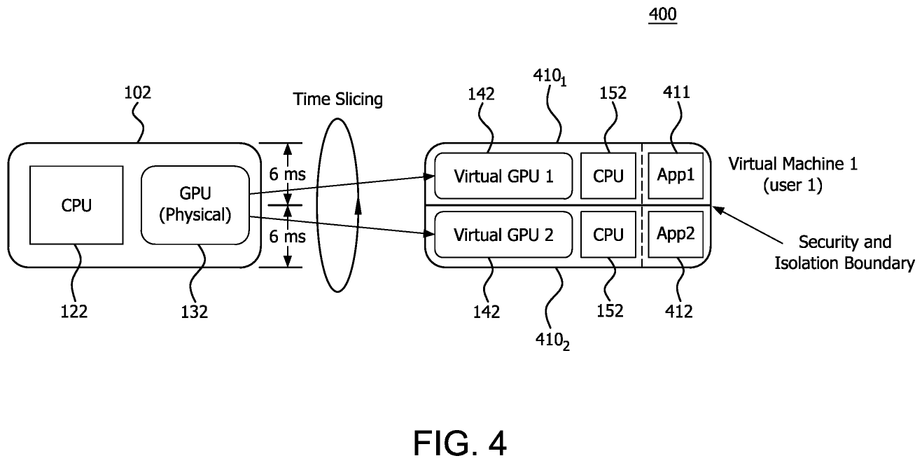

FIG. 4 is a block diagram of an example equalized virtual machine system 400 in accordance with an embodiment. In system 400, multiple VMs are created (410₁ and 410₂; while two VMs are illustrated for ease of understanding, a person of ordinary skill in the art will understand and appreciate that more than two VMs are possible in other embodiments of the present invention). The VMs created in FIG. 4 produce an isolation boundary between VM1 (user1) and VM2 (user2), who are executing App1 411 and App2 412.

In the system 400, VM1 and VM2 are equalized such that similar resource allocations are available to a single user (e.g., user 1 and user 2). In the present example, VM1 and VM2 are separated in the time domain by 6 ms time intervals. User 1 and User 2 are utilizing two different applications, as shown in FIG. 4. In another example, VM1 and VM2 may be utilized by a single user (e.g., User 1) running a first application (or applications) on VM1 and a second application (or applications) on VM2.

In some cases, however, as discussed above, a user may desire additional performance, such as QoS, for an application. In these cases, an unequalized virtualization may be desirable.

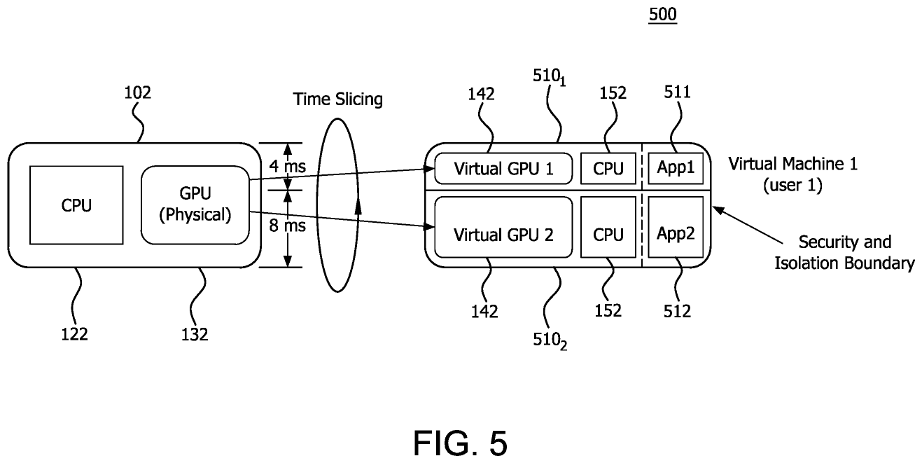

FIG. 5 is a block diagram of an example unequalized virtual machine system 500 in accordance with an embodiment. In system 500, again two VMs are created (VM1 5101 and VM2 510₂). In this example, a security and isolation boundary is created between user 1 on VM1 and user 2 on VM2 such that App1 511 executing on VM1 and App2 512 executing on VM2 are kept isolated and secure from one another.

In this unequalized case, however, although both VM1 and VM2 are separated by having the GPU time sliced in the time domain into two VMs, VM1 is allocated less time (e.g., 4 ms), while VM2 is allocated more resources (e.g., 8 ms or a greater amount of time) in order to allow App2 to access higher performance characteristics and hardware and software resources. Additionally, the physical memory allocated to each VM may also be split. That is, one VM may receive a greater allocation of physical memory than the other VM. This allocation may be the same or independent of the time slicing partitioning.

It should also be noted that the allocation of time resources and physical resources may not necessarily be similar. That is, VM2 may be allocated increased time resources but fewer physical resources than VM1 or vice versa. Alternatively, VM2 may be allocated both increased time resources and increased physical resources than VM1.

Referring back to FIGS. 4 and 5, a method of managing applications on a virtual machine is now described in greater detail below.

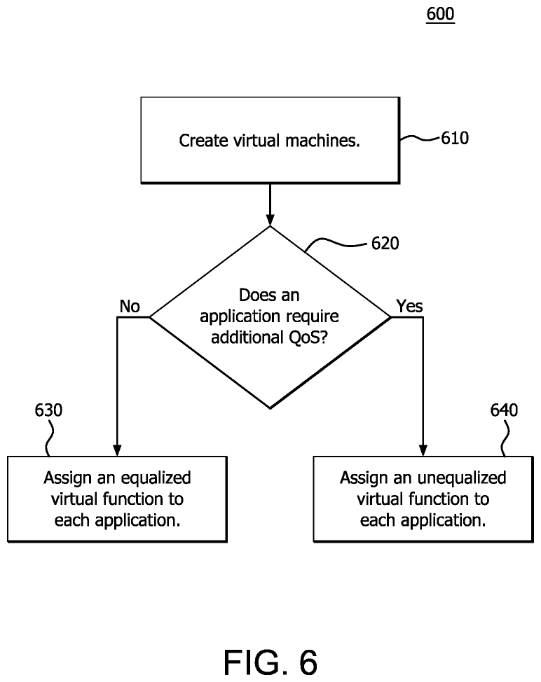

FIG. 6 is a flow diagram of an example method 600 of managing applications on a virtual machine. In step 610, virtual machines are created to provide a security and isolation boundary between applications for execution. For example, depending on the need for equalized virtualization or unequalized virtualization, the VM system 400 or 500 of FIGS. 4 and 5 respectively may be created.

That is, if an application does not require additional performance (step 620), an equalized virtual function is assigned to each application (step 630). For example, the VM system 400, where VM1 and VM2 are allocated equalized resources is assigned. That is, both VM1 and VM2 are allocated equal time resources and/or equal physical resources for use.

This may be assigned where the need for resources between competing applications is equal and both applications are able to execute without additional resource requirements.

However, if in step 620 an application does require additional resources, then an unequalized virtual function is assigned to each application (step 640).

For example, the VM system 500, where VM1 is assigned less resources than VM2 is assigned. In this case, the applications executing on VM2 are provided with additional resources to meet the performance (e.g., QoS) requirements. This may be useful in the case, for example, where the application for execution on VM2 is a graphics intensive application, such as a first-person shooter game or the like, while the application for execution on VM1 is an office based platform where the user may be utilizing word processing or spreadsheet software, such that high performance is not as necessary.

In accordance with the above, multiple partitions may be assigned to either the same VM or system. That is, an individual user can use these partitions to execute different applications on different partitions and receive the benefits of performance guarantees and isolation. For example, User 1 may desire to operate a first application with a first set of QoS criteria on a first VM and execute, in isolation, a second application with a second set of QoS criteria on a second VM.

Accordingly, multiple virtual machines can be created by splitting a physical GPU into multiple virtual GPUs. Those multiple virtual GPUs can be assigned to the same single user's VM or system. The user can then run one or more applications on each split GPU depending on the application's needs. This provides isolation and a performance guarantee to each application, thereby ensuring fair but constrained sharing of physical GPU resources in a fault tolerant manner.

Additionally, the user can choose between equal and unequal partitioning of physical GPU resources. The user therefore possesses flexibility and a way to improve utilization by choosing correct performance levels depending on the needs of applications the user is looking to execute.

The methods provided can be implemented in a general purpose computer, a processor, or a processor core. Suitable processors include, by way of example, a general purpose processor, a purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure. Further, although the methods and apparatus described above are described in the context of controlling and configuring PCIe links and ports, the methods and apparatus may be utilized in any interconnect protocol where link width is negotiated.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). For example, the methods described above may be implemented in the processor 102 or on any other processor in the computer system 100.

It should be noted that although the examples provided above refer to two virtual machines for example purposes, any number of virtual machines can be created for application execution.

What is claimed is:

1. A method for managing applications on a virtual machine, comprising:
creating a plurality of virtual machines on a computer system;
isolating each virtual machine from one another; and
allocating resources to each virtual machine based upon a resource requirement of an application executing on each virtual machine.

2. The method of claim 1 wherein a first virtual machine is created by isolating a first virtual processor from a second virtual processor as the second virtual machine.

3. The method of claim 2 wherein a first application executes on a first virtual machine and a second application executes on a second virtual machine.

4. The method of claim 3 wherein the first virtual processor and the second virtual processor are separated in the time domain.

5. The method of claim 4 wherein the first virtual processor and the second virtual processor are allocated a same number of time slots.

6. The method of claim 4 wherein the first virtual processor is allocated more time slots than the second virtual processor.

7. The method of claim 4 wherein the first processor is allocated more physical memory than the second processor.

8. The method of claim 2 wherein resources are allocated to the first virtual processor or the second virtual processor based upon a performance requirement.

9. The method of claim 8 wherein the performance requirement is a quality of service (QoS) requirement.

10. The method of claim 2 wherein a first user is allocated resources on the first virtual processor and a second user is allocated resources on the second virtual processor.

11. A computer system for managing applications, comprising:
a memory; and
a processor operatively coupled with and in communication with the memory, the processor configured to create a plurality of virtual machines within the processor, isolate each virtual machine from one another, and allocate resources to each virtual machine based upon a resource requirement of an application executing on each virtual machine.

12. The computer system of claim 11 wherein a first virtual machine is created by isolating a first virtual processor from a second virtual processor as the second virtual machine.

13. The computer system of claim 12 wherein a first application executes on the first virtual machine and a second application executes on the second virtual machine.

14. The computer system of claim 13 wherein the first virtual processor and the second virtual processor are separated in the time domain.

15. The computer system of claim 14 wherein the first virtual processor and the second virtual processor are allocated a same number of time slots.

16. The computer system of claim 14 wherein the first virtual processor is allocated more time slots than the second virtual processor.

17. The computer system of claim 14 wherein the first processor is allocated more physical memory than the second processor.

18. The computer system of claim 12 wherein resources are allocated to the first virtual processor or the second virtual processor based upon a performance requirement.

19. The computer system of claim 18 wherein the performance requirement is a quality of service (QoS) requirement.

20. A non-transitory computer-readable medium for managing applications, the non-transitory computer-readable medium having instructions recorded thereon, that when executed by the processor, cause the processor to perform operations including:
creating a plurality of virtual machines on a computer system;
isolating each virtual machine from one another; and
allocating resources to each virtual machine based upon a resource requirement of an application executing on each virtual machine.
